(19) United States
(12) Patent Application Publication
(10) Pub. No.: US 2025/0036085 A1
(43) Pub. Date: Jan. 30, 2025

(54) HOURGLASS TIMERS WITH ALARM TRIGGERS

(71) Applicant: Benjamin Robert Sawyer, Kingfield, ME (US)

(72) Inventor: Benjamin Robert Sawyer, Kingfield, ME (US)

(21) Appl. No.: 18/528,315

(22) Filed: Dec. 4, 2023

Related U.S. Application Data
(60) Provisional application No. 63/516,234, filed on Jul. 28, 2023.

(51) Int. Cl. G04F 1/06

(52) U.S. Cl. CPC G04F 1/063

(57) ABSTRACT

Timers including an hourglass, a frame, and a trigger. The hourglass includes a top globe, a bottom globe, and a neck. The neck defines a sand passageway between the top globe and the bottom globe. The frame pivotally supports the hourglass at the neck. The trigger is pivotally coupled to the frame in a position to be engaged by the bottom globe when the hourglass pivots on the frame to a selected extent. The hourglass is configured to allow the sand to flow from the top globe to the bottom globe through the neck under the influence of gravity. The hourglass pivots on the frame in response to sand flowing from the top globe to the bottom globe. The selected extent the hourglass must pivot for the bottom globe to engage the trigger corresponds to a selected amount of time. Some examples further include a sonic device and/or a base.

### CROSS REFERENCE TO RELATED APPLICATIONS

This application claims priority to copending U.S. Application, Ser. No. 63/516,234, filed on Jul. 28, 2023, which is hereby incorporated by reference for all purposes.

### BACKGROUND

The present disclosure relates generally to timers. In particular, hourglass timers with alarm triggers are described.

Timers are useful for keeping track of how much time has elapsed. For example, one may wish to know when 30 minutes has elapsed when baking to know when to adjust an oven temperature per instructions in a recipe. Alternatively, one may wish to know when 60 minutes has elapsed when conducting a paid consultation specified for one hour in length.

A variety of timer types exist, including mechanical and electronic timers. This document will focus on mechanical timers; in particular, hourglass timers.

Hourglass timers function by allowing a selected amount of sand or other granular material to pass from one region of an hourglass to another under the force of gravity. The amount of time required for the sand to change regions is known. Thus, the timer indicates when the known amount of time elapses when the sand fully transfers from the initial region to the new region.

In 1878, Joaquim De Macedo patented an egg boiling timer that used an hourglass in a pivoting carriage to sound a bell (Improvement In Time-Signals, U.S. Pat. No. 199,419). An alternative method for a similar egg timer was patented by Ada Roberts in 1916 (Audible Culinary Alarm, U.S. Pat. No. 1,175,816). In 1936 Erwin Koester patented a very different looking timer that operated on similar principles to Macedo and Roberts (Minute Sand Glass, U.S. Pat. No. 2,064,759). The complete disclosures of U.S. Pat. Nos. 199,419, 1,175,816, and 2,064,759 are herein incorporated by reference for all purposes.

Since the Macedo, Roberts, and Koester patents almost a century ago, there has been very little innovation in the hourglass timer space. Hourglass timer innovation probably stalled because hourglasses were largely abandoned in favor of the more precise mechanical and digital timers developed in the intervening decades. However, interest in hourglass timers still exists because of their elegance and simplicity. There is a desire to use hourglass timers instead of modern timers, but conventional hourglass timers are not entirely satisfactory.

For example, existing hourglass timers require one to observe the last bit of sand transfer from the original region to the new region of the hourglass to know when the set amount of time elapses. When one fails to observe the final transfer, one can know only that at least the set amount of time has elapsed and that the set amount of time elapsed an unknown amount of time prior.

It would be desirable to have an hourglass timer capable of triggering an alarm so that one could be informed when the set amount of time has elapsed without having to observe the sand transferring between regions of the hourglass. It would be beneficial if an hourglass timer included an audible or sonic alarm to indicate with sound when the set amount of time elapsed. An audible alarm would allow one to be visually focused on things other than the hourglass timer. It would be further advantageous if the hourglass timer allowed for setting alarm triggers of varying durations to enable one to set an alarm for a desired duration rather than being limited to a single, set duration.

Thus, there exists a need for hourglass timers that improve upon and advance the design of known hourglass timers. Examples of new and useful hourglass timers relevant to the needs existing in the field are discussed below.

### SUMMARY

The present disclosure is directed to timers including an hourglass, a frame, and a trigger. The hourglass includes a top globe, a bottom globe, and a neck. The hourglass is configured to allow the sand to flow from the top globe to the bottom globe through the neck under the influence of gravity. The hourglass pivots on the frame in response to sand flowing from the top globe to the bottom globe.

The neck defines a sand passageway between the top globe and the bottom globe. The frame pivotally supports the hourglass at the neck with the bottom globe disposed below the top globe. The trigger is pivotally coupled to the frame in a position to be engaged by the bottom globe when the hourglass pivots on the frame to a selected extent. The selected extent the hourglass must pivot for the bottom globe to engage the trigger corresponds to a selected amount of time.

Some examples of the timer include a sonic device in a position to be engaged by the trigger. Certain examples of the timer include a base supporting the frame and the sonic device.

### BRIEF DESCRIPTION OF THE DRAWINGS

FIG. 1 is an exploded view of a first example of an hourglass timer.

FIG. 2A is a perspective view of a trigger adjustment mechanism of the hourglass timer shown in FIG. 1 depicting a variable finger aligned with a fixed finger.

FIG. 2B is a perspective view of the trigger adjustment mechanism shown in FIG. 2A depicting the variable finger pivoted away from the fixed finger.

FIG. 3A is a front-left side perspective view of a frame, a base, and a trigger of the hourglass timer shown in FIG. 1.

FIG. 3B is a rear-right side perspective view of the frame, the base, and the trigger of the hourglass timer shown in FIG. 1.

FIG. 4A is a front-left side perspective view of the hourglass timer shown in FIG. 1.

FIG. 4B is a rear-right side perspective view of the hourglass timer shown in FIG. 1.

FIG. 5A is a left side elevation view of the hourglass timer shown in FIG. 1 depicting a sphere supported on an upper end of a track defined by the frame prior to the sphere being displaced by the trigger.

FIG. 5B is a left side elevation view of the hourglass timer shown in FIG. 1 depicting the sphere engaging an acoustic device and producing a sound after being displaced by the trigger and rolling down the track.

FIG. 6A is a left side elevation view of the hourglass timer shown in FIG. 1 depicting the sphere supported on the upper end of the track prior to the sphere being displaced by the trigger with a variable finger pivoted towards the bottom globe to reduce the selected extent the hourglass must pivot for the bottom globe to engage the trigger.

FIG. 6B is a left side elevation view of the hourglass timer shown in FIG. 1 depicting the sphere engaging an acoustic device and producing a sound after being displaced by the trigger and rolling down the track.

FIG. 7 is a perspective view of an alternative trigger without a trigger adjustment mechanism.

FIG. 8 is an exploded view of a second example of an hourglass timer.

FIG. 9A is an exploded view of a portion of a frame and a trigger of the hourglass timer shown in FIG. 8.

FIG. 9B is a front-right side perspective view of the trigger pivotally supported on the portion of the frame of the hourglass timer shown in FIG. 8.

FIG. 10 is a front-left side perspective view of the hourglass timer shown in FIG. 8.

FIG. 11A is a front-left side perspective view of the hourglass timer shown in FIG. 8 depicting the trigger in a cocked position and a bottom globe of an hourglass spaced from the trigger.

FIG. 11B is a front-left side perspective view of the hourglass timer shown in FIG. 8 depicting the trigger in the cocked position and the bottom globe engaging the trigger.

FIG. 11C is a front-left side perspective view of the hourglass timer shown in FIG. 8 depicting a striker engaging an acoustic device after the trigger pivots away from the cocked position.

FIG. 12 is a front-left side perspective view of the hourglass timer shown in FIG. 8 depicting the trigger in a cocked position that is pivoted closer to the bottom globe to reduce the selected extent the hourglass must pivot for the bottom globe to engage the trigger.

### DETAILED DESCRIPTION

The disclosed timers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various timers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Hourglass Timers with Alarm Triggers

With reference to the figures, hourglass timers with alarm triggers will now be described. The hourglass timers discussed herein function to activate a trigger when a selected amount of time elapses. The trigger may be used to activate a sonic device configured to produce a sound to provide audible notice that the selected amount of time has elapsed. The novel hourglass timers described herein beneficially provide an analog method of timing an activity that does not rely on digital, electrical, or spring powered timers.

The reader will appreciate from the figures and description below that the presently disclosed timers address many of the shortcomings of conventional timers. For example, the novel timers disclosed herein do not require one to visually observe sand transferring in an hourglass to know when a set amount of time elapses. The novel hourglass timers disclosed herein are capable of triggering an alarm so that one can be informed when the set amount of time has elapsed without having to observe the sand transferring between regions of the hourglass. Beneficially, some examples of the novel hourglass timers include an audible or sonic alarm to indicate with sound when the set amount of time elapsed to allow one to be visually focused on things other than the hourglass timer. Advantageously, certain examples of the novel hourglass timers allow for setting alarm triggers of varying durations to enable one to set an alarm for a desired duration rather than being limited to a single, set duration.

The novel hourglass timers can be configured to track time durations anywhere from 10 minutes to an hour or more, making them useful for a wide range of applications. In contrast, prior art hourglass timer disclosures focused on shorter durations, such as durations under 10 minutes.

The novel hourglass timers described herein are simpler and more elegant than conventional hourglass timers. For example, the novel hourglass timers do not rely on a rotating carriage. In contrast, conventional hourglass timers described in prior art patents rely on fixing the hourglass to a rotating carriage.

Advantageously, the novel hourglass timers discussed below utilize the dynamic rotation of an hourglass and a trigger mechanism to easily achieve a relatively wide range of durations. In contrast, conventional hourglass timers are limited to a narrow range of durations by means of weighted devices attached to a carriage containing the hourglass (Macedo, Koester), or to the body of the hourglass itself (Roberts).

Another benefit of the novel hourglass timers described herein is that they capitalize on the dynamic rotation of the hourglass to provide an additional indicator of elapsed time. In particular, the novel hourglass timers provide a second indicator of the duration of elapsed time beyond the transfer of sand between globes of an hourglass; namely, a pivot position of the hourglass. Whereas prior art hourglass timers keep the hourglass motionless until the moment of actuation, the novel hourglass timers herein enable the hourglass to pivot as sand transfers between the globes to provide an additional indicator of elapsed time.

The novel hourglass timers described in the present document are aesthetically pleasing and blend function with visual appeal. In contrast, conventional hourglass timers tend to appear ungainly and sacrifice a pleasing form to achieve their timing function.

### Contextual Details

Ancillary features relevant to the timers described herein will first be described to provide context and to aid the discussion of the timers.

### Sand

The hourglass timers described herein will typically utilize sand, another granular material, or a liquid within an hourglass to track the passage of time. The sand, other granular material, or liquid (hereinafter simply sand) is contained within an hourglass and is selectively transferred between regions of the hourglass to track the passage of time. A selected quantity of sand within the hourglass corresponds to a selected period of time when the sand is allowed to transfer from one region of the hourglass to another under the influence of gravity.

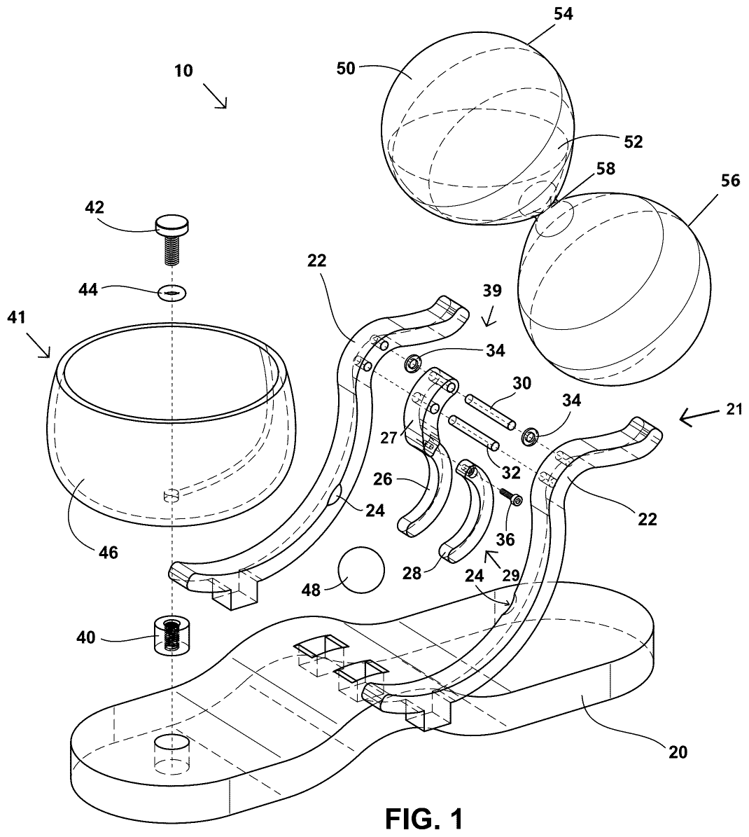

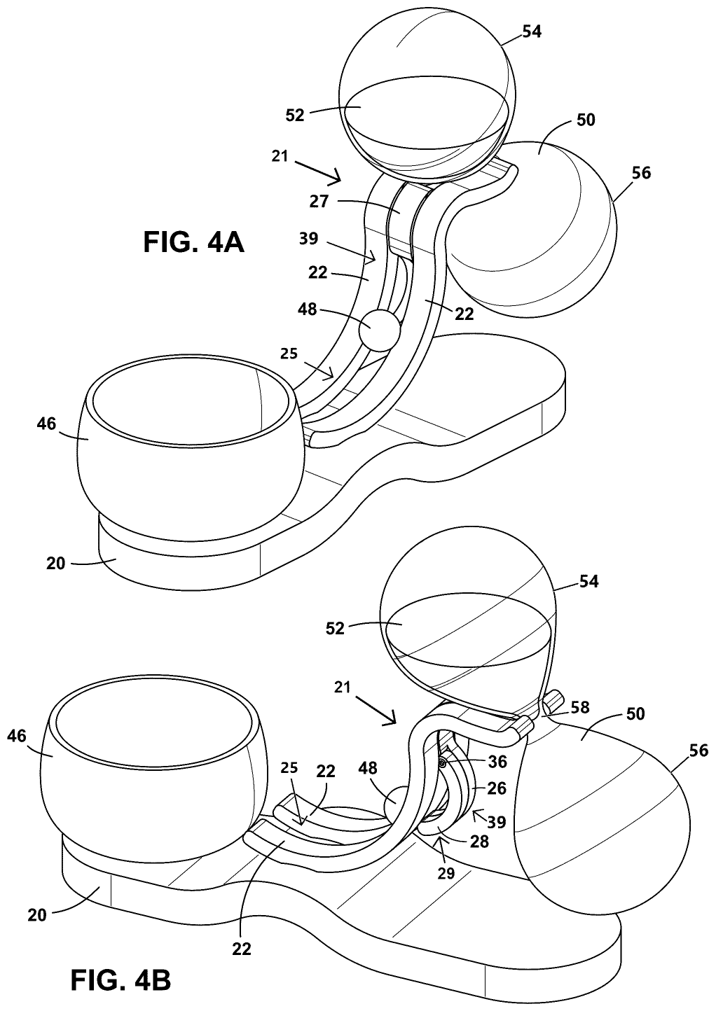

Suitable sand examples, sand 52 and sand 82, are depicted within hourglasses 50 and 80, respectively, in FIGS. 1, 4A-6B, 8, and 10-12. The sand may be any currently known or later developed type of sand, granular material, or liquid suitable for hourglass applications. The quantity of sand contained in the hourglass may be selected to provide a desired time duration for the hourglass in normal usage.

The sand may be added to and sealed within the hourglass when the hourglass is manufactured. Alternatively, the sand may be obtained separate from the hourglass and selectively added and removed from the hourglass. In some examples, the user will add different amounts of sand to the hourglass when the user desires the hourglass to indicate different time durations.

### Hourglass Timer Embodiment One

With reference to FIGS. 1-7, a first example of a timer, timer 10, will now be described. Timer 10 includes an hourglass 50, a frame 21, a trigger 39, a sonic device 41, and a base 20. In some examples, the timer does not include one or more features included in timer 10. For example, some timer examples do not include a sonic device and/or a base. In other examples, the timer includes additional or alternative features than depicted in FIGS. 1-7.

The size and shape of the timer may vary in different examples. For example, the timer may be larger or smaller than depicted in FIGS. 1-7. Further, the timer may adopt different aesthetic or functional shapes while still achieving the same primary functions. The materials used to construct the timer may be different in different examples.

### Hourglass

Hourglass 50 functions to track a given span of time. In particular, hourglass 50 tracks the time it takes for sand 52 to travel from one region of hourglass 50 to another region. The quantity of sand 52 contained in hourglass 50 may vary to provide a different selected amount of time for the sand to move between regions of hourglass 50.

As shown in FIGS. 1 and 4A-6B, hourglass 50 includes a top globe 54, a bottom globe 56, and a neck 58. Top globe 54 and bottom globe 56 define interior sand containing regions. Neck 58 defines a sand passageway between the interior sand containing regions of top globe 54 and bottom globe 56. Top globe 54 and bottom globe 56 are configured the same and may be interchangeably oriented relative to each other. As used herein, top globe 54 refers to the major portion of hourglass 50 oriented above the other major portion; namely, bottom globe 56.

Under the influence of gravity, sand 52 flows from top globe 54 to bottom globe 56 through neck 58. A selected quantity of sand 52 may be added to hourglass 50 corresponding to a selected amount of time for sand 52 to flow from top globe 54 to bottom globe 56 through neck 58. Different selected amounts of time may be facilitated by adding more or less sand to hourglass 50.

As can be seen in FIGS. 1 and 4A-6B, hourglass 50 is pivotally supported on frame 21 at neck 58. Accordingly, hourglass 50 is configured to pivot relative to frame 21 as sand 52 flows from top globe 54 to bottom globe 56 through neck 58. Sand 52 flowing into bottom globe 54 shifts weight to bottom globe 56 and creates a moment arm for hourglass 50 relative to neck 58, which acts as a pivot point.

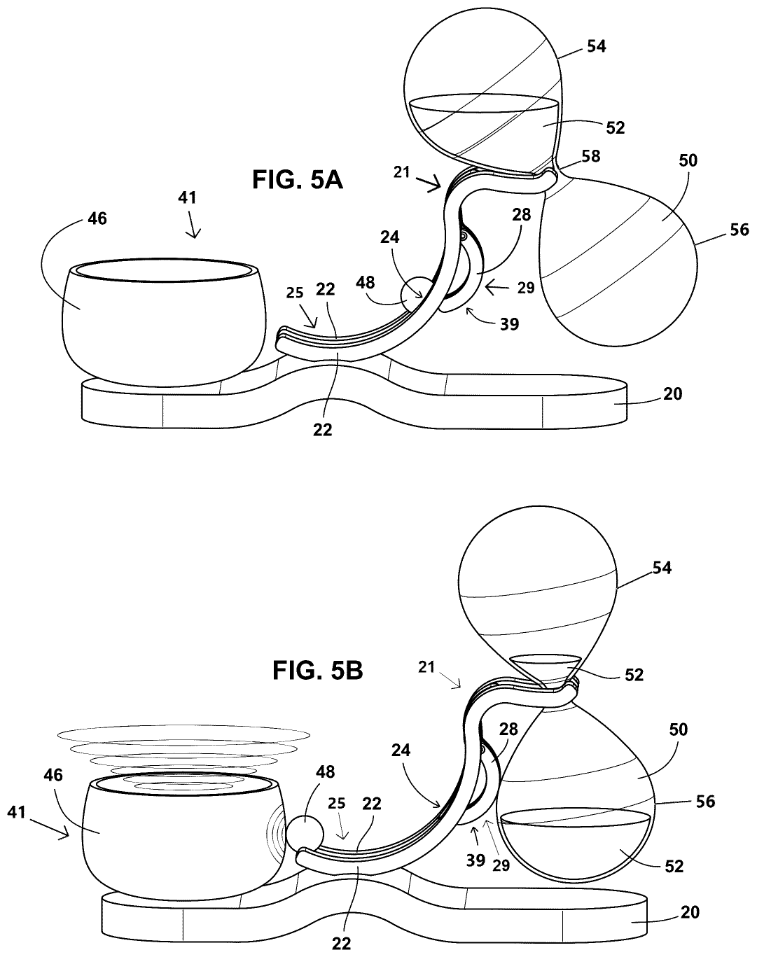

With reference to FIG. 5A, the reader can see hourglass 50 in an initial pivot position with all of sand 52 in top globe 54. With reference to FIG. 5B, the reader can see hourglass 50 pivoted towards trigger 39 as a result of sand flowing from top globe 54 into bottom globe 56 through neck 58. In particular in FIG. 5B, hourglass 50 pivots relative to frame 21 to a selected extent where bottom globe 56 engages trigger 39 as a result of a given amount of sand 52 flowing into bottom globe 56. The given amount of sand may be selected to correspond to a selected amount of time tracked by timer 10.

In the present example, hourglass 50 is formed from glass. In other examples, the hourglass is formed from a polymer material. The hourglass may be formed from any currently known or later developed material suitable for hourglass applications.

### Frame

Frame 21 functions to pivotally support hourglass 50. Further, frame 21 serves to support trigger 39 and a portion of sonic device 41. In particular, frame 21 supports trigger 39 in a position where it can be engaged by bottom globe 56 of hourglass 50. Further, frame 21 supports a sphere 48 of sonic device 41 where it can be engaged by trigger 39.

In the present example, the reader can see in FIGS. 1 and 3A-6B that frame 21 is mounted to base 20. However, in other examples the frame is freestanding and rests on a surface. Some examples of the timer do not include a base.

As shown in FIGS. 1 and 3A-6B, frame 21 includes two arms 22. Arms 22 are spaced from each other and support trigger 39 between them. The reader can see in FIGS. 1 and 3A-6B that arms 22 are curved and have the same shape. Arms 22 of frame 21 define a fork configured to pivotally support hourglass 50 at neck 58. The reader can see that frame 21 supports hourglass 50 at an angle with neck 58 defining a pivot point for hourglass 50 to pivot relative to frame 21.

As shown in FIG. 1, each arm 22 defines recesses on a side of each arm 22 facing the other arm. The recesses are complementarily configured with a pivot rod 30 and a limit rod 32 of trigger 39. As shown in FIG. 1, rods 30 and 32 are received in the corresponding recesses defined in arms 22.

With reference to FIG. 1, trigger 39 is suspended centrally between arms 22 by pivot rod 30 extending through washers 34 and inserting into the recesses of arms 22. Limit rod 32 constrains the rotational range of trigger 39 when limit rod 32 inserts into the recesses of arms 22.

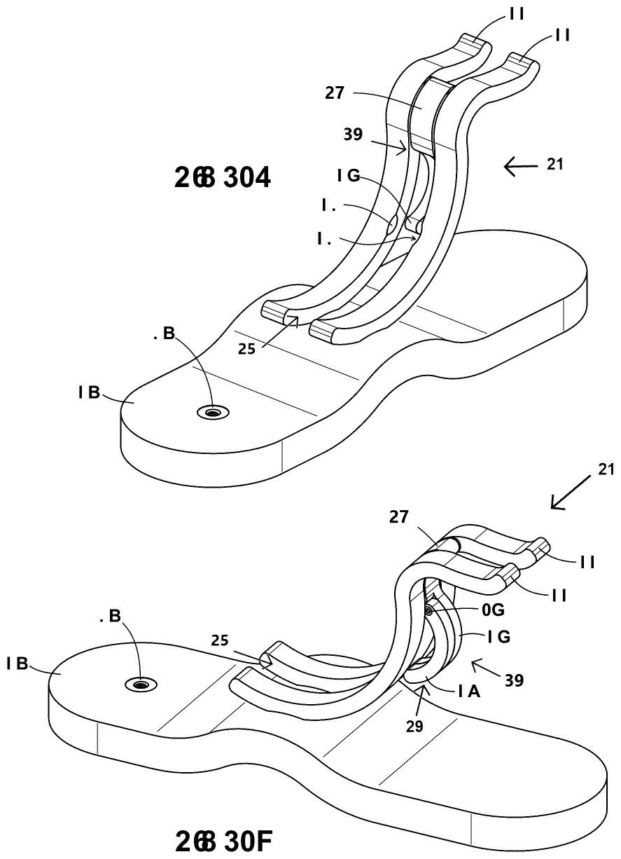

As depicted in FIGS. 3A-6B, arms 22 cooperate to define a track 25. Track 25 provides a path for sphere 48 to roll down frame 21 and to collide with a sonic bowl 46 of sonic device 41 to produce a sound. The reader can see that the spacing between arms 22 is selected to complement the diameter of sphere 48 so that sphere 48 can readily and controllably roll down track 25 when engaged by trigger 39.

As shown in FIGS. 1, 3A, 4A, and 5A-6B, arms 22 cooperate to define a seat 24 complementarily configured with sphere 48. Sphere 48 rests in seat 24 until engaged by trigger 39. When engaging sphere 48, trigger 39 pushes sphere 48 out of seat 24. After being displaced from seat 24, sphere 48 rolls down track. 25 until it impacts sonic bowl 46.

In the present example, arms 22 are formed from metal. In other examples, the arms are formed from wood, a ceramic material, or a polymer. The arms may be formed from any currently known or later developed material.

The size of frame 21 may be larger or smaller in different examples. The reader should understand that the shape of the frame may vary yet still function to support the hourglass, the trigger, and portions of the sonic device.

### Trigger

Trigger 39 functions to selectively engage an alarm, such as sonic device 41, when engaged by hourglass 50. In the example depicted in FIGS. 1-6, trigger 39 engages sphere 48 when bottom globe 56 engages trigger 39 after hourglass 50 pivots to the selected extent relative to frame 21. In particular, trigger 39 pushes sphere 48 out of seat 24 and causes sphere 48 to roll down track 25 until it impacts sonic bowl 46.

As shown in FIGS. 1 and 3A-6B, trigger 39 is mounted to frame 21. In particular, trigger 39 is mounted to frame 21 in a position where trigger 39 can be engaged by bottom globe 56 of hourglass 50. With reference to FIG. 1, trigger 39 is suspended centrally between arms 22 by pivot rod 30 extending through washers 34 and inserting into the recesses of arms 22. Limit rod 32 constrains the rotational range of trigger 39 when limit rod 32 inserts into the recesses of arms 22.

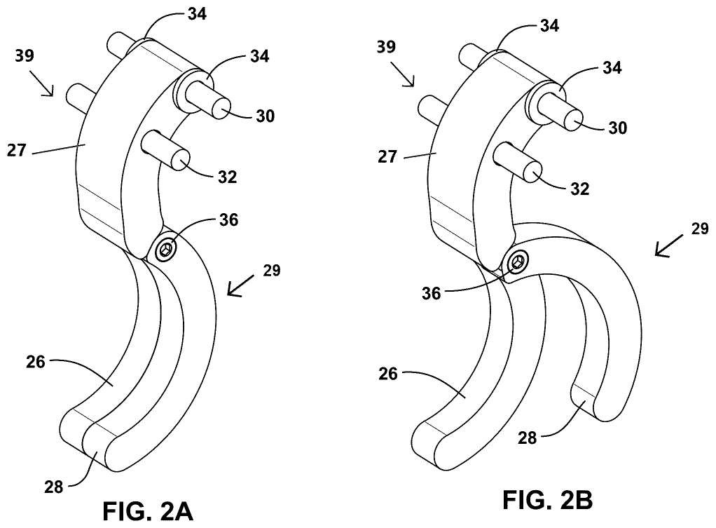

With reference to FIGS. 2A and 2B, the reader can see that trigger 39 includes a shoulder 27, a fixed finger 26, a trigger adjustment mechanism 29, a pivot rod 30, a limit rod 32, and washers 34. Trigger adjustment mechanism 29 is movably coupled to shoulder 27 while fixed finger 26 is integrally coupled to shoulder 27. Accordingly, fixed finger 26 and shoulder 27 form a unitary member and are sometimes collectively referred to herein as simply a fixed finger.

Trigger adjustment mechanism 29 enables the selected extent that hourglass 50 must pivot for bottom globe 56 to engage trigger 39 to be adjusted. In turn, trigger adjustment mechanism 29 allows for adjusting the time duration that elapses before hourglass 50 pivots to the selected extent necessary for bottom globe 56 to engage trigger 39.

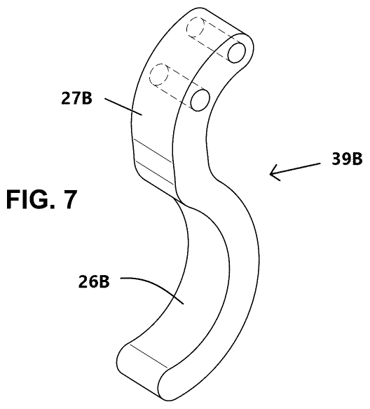

The trigger adjustment mechanism is optional and is not present in all examples. For example, FIG. 7 depicts a trigger 39B without a trigger adjustment mechanism. Instead, trigger 39B includes only a fixed finger 26B extending from a shoulder 27B.

As shown in FIGS. 1-2B, 3B, 4B, and 5B-6B, trigger adjustment mechanism 29 includes a variable finger 28 and a fastener 36. Variable finger 28 is pivotally connected to shoulder 27 via fastener 36. Fastener 36 is configured to selectively secure variable finger 28 in a desired pivot position relative to fixed finger 26.

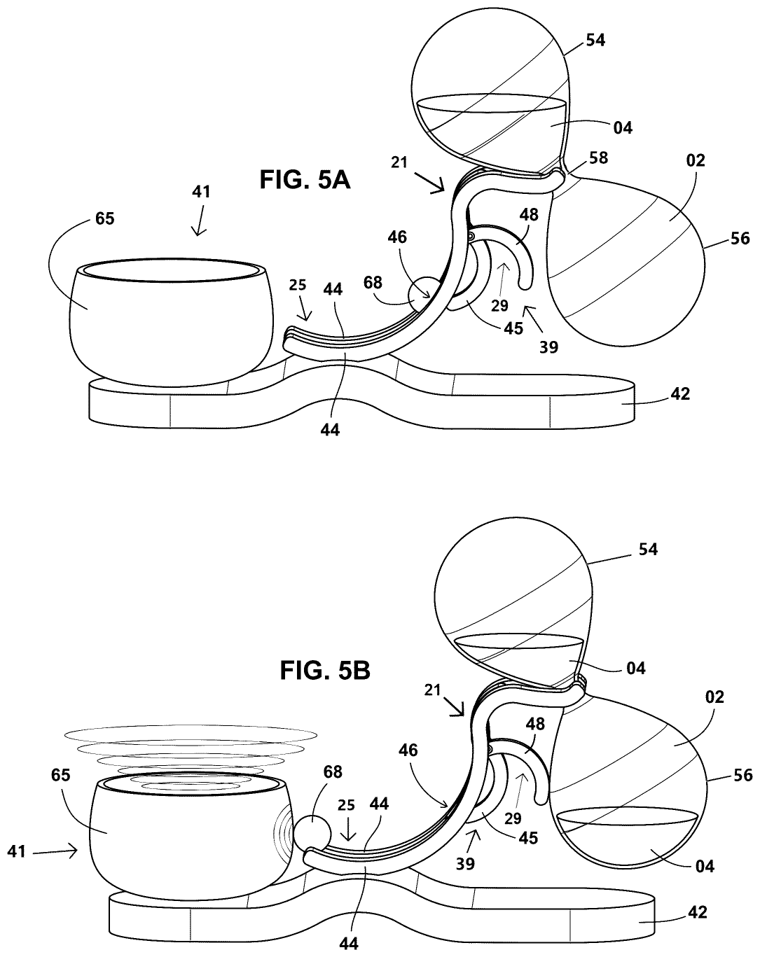

Selectively pivoting and fixing variable finger 28 towards bottom globe 56 reduces the selected extent hourglass 50 must pivot for bottom globe 56 to engage variable finger 28 of trigger 39. As shown in FIGS. 6A and 6B, variable finger 28 drives fixed finger 26 to pivot relative to frame 21 and to displace sphere 48 from seat 24 when variable finger 28 is pushed by bottom globe 56.

As shown in FIG. 1, variable finger 28 and shoulder 27 define aligned recesses through which fastener 36 inserts to pivotally mount variable finger 28 to shoulder 27. Fastener 36 and the recess defined in variable finger 28 are complementarily threaded to enable fastener 36 to be selectively tightened to fix variable finger 28 in a desired pivot position relative to fixed finger 26.

In the present example, fixed finger 26 and variable finger 28 are formed from metal. In other examples, the fingers are formed from wood, a ceramic material, or a polymer. The fingers may be formed from any currently known or later developed material.

### Sonic Device

Sonic device 41 serves to produce a sound when engaged by trigger 39. Accordingly, sonic device 41 and trigger 39 cooperate to function as an audible alarm when a selected amount of time has elapsed and hourglass 50 pivots to a selected extent necessary for bottom globe 56 to engage trigger 39. One can select the amount of elapsed time for sonic device 41 to produce an alarm sound by adjusting the pivot position of variable finger 28 of trigger adjustment mechanism 29 and/or by adjusting the amount of sand 52 in hourglass 50.

In the present example, as shown in FIGS. 1 and 4A-6B, sonic device 41 includes a sonic bowl 46 and a weighted sphere 48. Sonic device 41 produces a sound when sphere 48 rolls down track 25 and collides with sonic bowl 46.

As shown in FIGS. 5B and 6B, sonic bowl 46 is configured to convert impact energy transferred from sphere 48 into sound waves. Sonic bowl 46 is sometimes referred to as a singing bowl. Any object capable of producing sound reliably when impacted by a sphere or other object may be used in place of sonic bowl 46.

As shown in FIG. 1, sonic bowl 46 is mounted to base 20 adjacent to an end of track 25 with an anchor nut 40, a thumb screw 42, and a silicone washer 44. However, the sonic bowl may be attached to the base by any suitable means or may simply rest on the base-especially if the bowl is heavy enough to resist sliding when impacted by the sphere. In examples where the timer does not include a base, the sonic bowl may rest on a surface next to the track in a position to be impacted by the sphere rolling down the track after being dislodged from the seat.

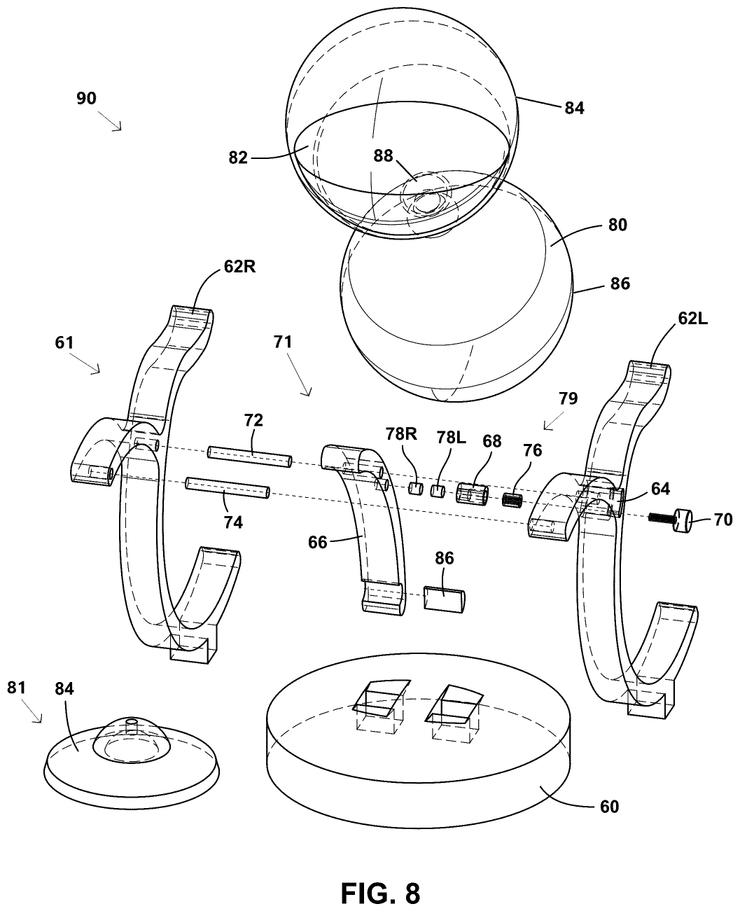

The sonic device may be any currently known or later developed device configured to produce a sound when engaged by a trigger. An example of a sonic device configured differently than sonic device 41 is shown in FIGS. 8 and 10-12. FIGS. 8 and 10-12 depict an example of a sonic device 81 including a cymbal 84 and a striker 86 mounted to a pivoting finger 66. The sonic device could be an electronic sonic device in addition to other forms of mechanical sonic devices shown in the figures.

### Base

Base 20 serves as an optional platform for other components of timer 10, including frame 21 and sonic device 41. Some timer examples do not include a base. In such examples, the frame and sonic device rest on the ground or a surface.

The reader can see in FIGS. 1 and 3A-6B that frame 21 mounts to a humped region of base 20. Frame 21 mounts to base 20 by inserting projections extending from arms 22 into recesses formed in the humped region of base 20. However, the frame may attach to the base by any currently known or later developed means.

As shown in FIG. 1, sonic bowl 46 is mounted to base 20 adjacent to an end of track 25. Mounting sonic bowl 46 to base 20 restricts sonic bowl 46 from sliding away from track 25 in response to sphere 48 impacting sonic bowl 46. In the present example, sonic bowl 46 is mounted to base 20 with an anchor nut 40, a thumb screw 42, and a silicone washer 44. Base 20 defines a recess complementarily configured with anchor nut 40 to receive anchor nut 40.

As depicted in FIGS. 1 and 3A-6B, base 20 is elongate with a medial humped region. The humped region elevates frame 21 and provides space for bottom globe 56 between frame 21 and a lower portion of base 20 when hourglass 50 pivots to the selected extent. The size and shape of the base may vary in different examples.

In the present example, base 20 is formed from metal. In other examples, the base is formed from wood, a ceramic material, or a polymer. The base may be formed from any currently known or later developed material.

### Additional Embodiment

With reference to the figures not yet discussed, the discussion will now focus on an additional timer embodiment. The additional embodiment includes many similar or identical features to timer 10. Thus, for the sake of brevity, each feature of the additional embodiment below will not be redundantly explained. Rather, key distinctions between the additional embodiment and timer 10 will be described in detail and the reader should reference the discussion above for features substantially similar between the different timer examples.

### Second Embodiment

Turning attention to FIG. 8-12, a second example of a timer, timer 90, will now be described. As can be seen in FIG. 8, timer 90 includes an hourglass 80, a frame 61, a trigger 71, a sonic device 81, and a base 60.

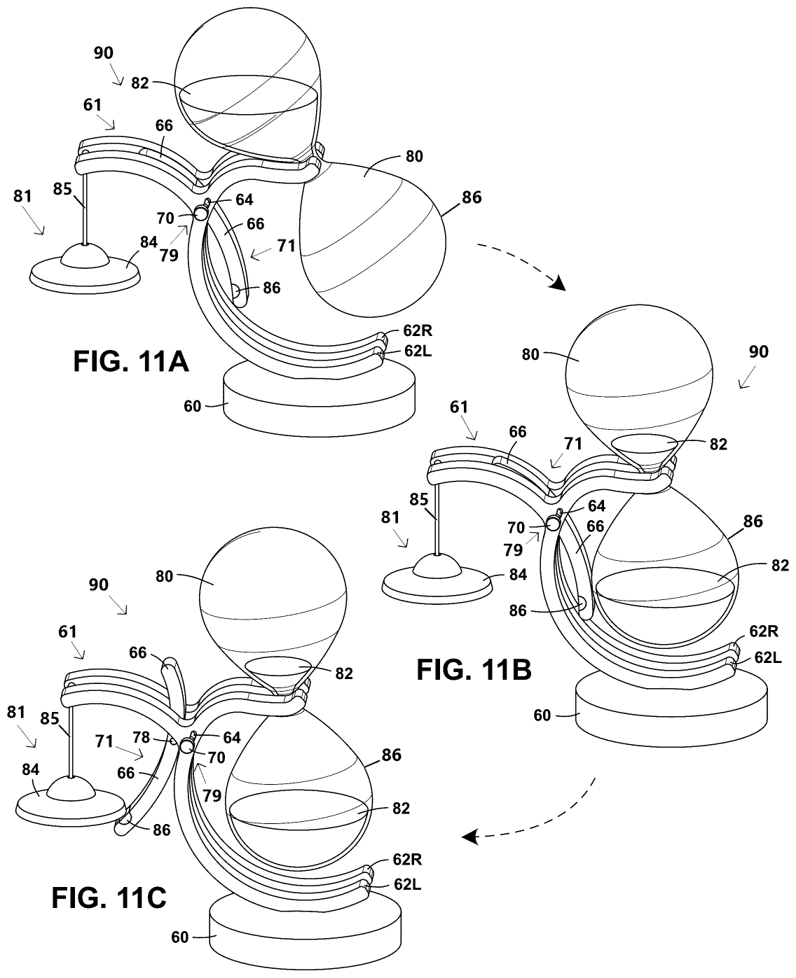

As shown in FIG. 8, hourglass 80 contains sand 82 and includes an upper globe 84, a lower globe 86, and a neck 88. In use, as shown in FIGS. 11A-11C, sand 82 flows from upper globe 84 to lower globe 86 through neck 88, which causes hourglass 80 to pivot relative to frame 61. As shown in FIGS. 11A-11C, after a selected duration of time, hourglass 80 pivots to a selected extent necessary for lower globe 86 to contact trigger 71. Lower globe 86 contacting trigger 71 causes trigger 71 to swing into sonic device 81 to produce a sound.

Frame 61 includes a first arm 62R and a second arm 62L. Frame 61 mounts to base 60 when projections extending from first arm 62R and second arm 62L insert into corresponding recesses formed in base 60. Hourglass 82 is pivotally supported on frame 61 and sonic device 81 is suspended from frame 21.

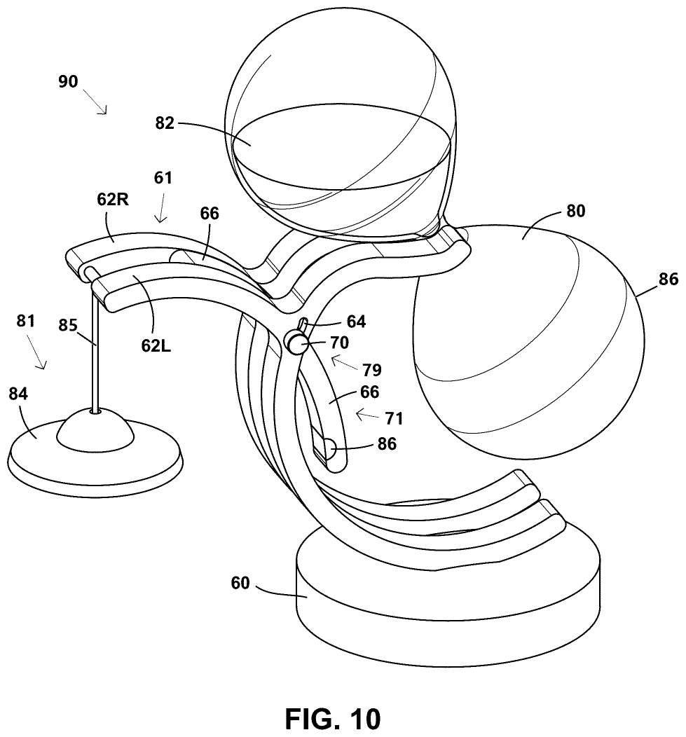

A key distinction between timer 90 and timer 10 is that sonic device 81 includes a cymbal 84 and a striker 86 rather than a sonic bowl 46 and a sphere 48. The reader can see in FIGS. 10-12 that cymbal 84 is suspended from frame 61 by a cord 85 secured to a support rod 74 mounted to frame 61. Striker 86 is mounted to a finger 66 of trigger 71. Cymbal 84 is engaged or struck by striker 86 when finger 66 dynamically pivots towards cymbal 84 when displaced from a cocked position. With reference to FIG. 11C, cymbal 84 produces a sound when striker 86 strikes cymbal 84.

As shown in FIGS. 8-12, trigger 71 is configured differently than trigger 39. With reference to FIG. 8, trigger 71 includes a finger 66, a pivot rod 72, and a trigger adjustment mechanism 79. With continued reference to FIG. 8, trigger adjustment mechanism 79 includes a first magnet 78R, a second magnet 78L, a slider 68, a threaded insert 76, and a thumb screw 70.

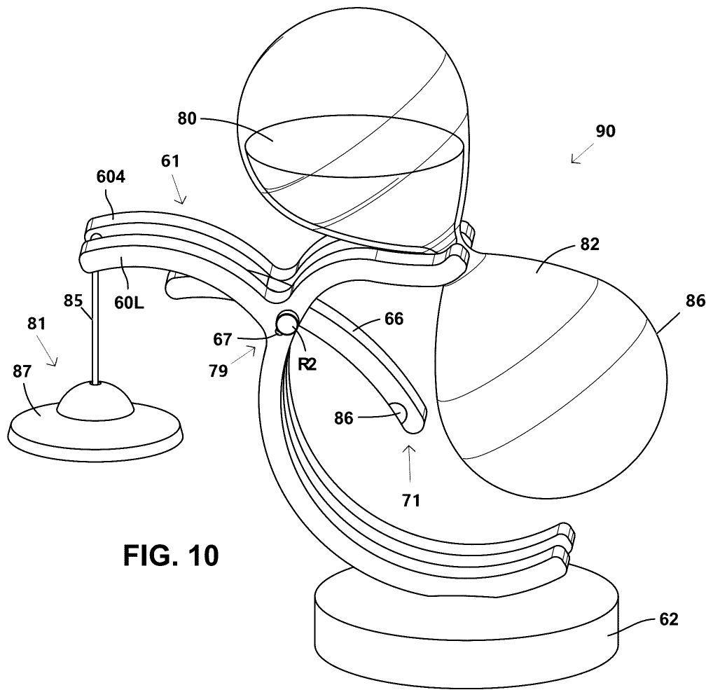

By comparing FIGS. 11A-11C and FIG. 12, the reader can see that trigger adjustment mechanism 79 functions to selectively adjust, set, and maintain the cocked pivot position of finger 66 relative to frame 61 and hourglass 80. By selectively pivoting finger 66 closer to hourglass 80, bottom globe 86 contacts or engages finger 66 sooner. Bottom globe 86 contacting finger 66 sooner causes trigger 61 to activate sonic device 81 with less time having elapsed.

In particular, pivoting and fixing finger 66 closer to hourglass 80 triggers finger 66 to pivot under the influence of gravity sooner from its cocked position set and maintained by trigger adjustment mechanism 79. Once finger 66 is displaced from its cocked position set and maintained by trigger adjustment mechanism 79, finger 66 swings towards cymbal 84 until striker 86 mounted to finger 66 collides with cymbal 84 at a contact position to produce a sound. Thus, a user may selectively set the cocked position of finger 66 with trigger adjustment mechanism 79 to select the time duration required for timer 90 to trigger an alarm sound with sonic device 81.

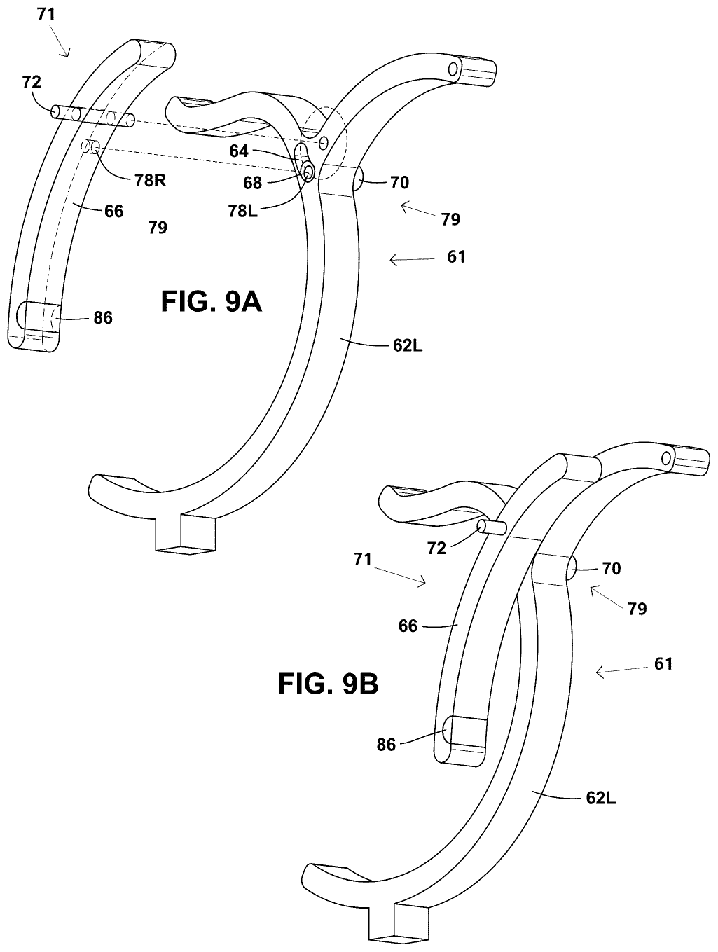

With reference to FIGS. 8-9B, finger 66 is a curved member and is suspended between arms 62R and 62L of frame 61 by pivot rod 72 at a medial position of finger 66. Pivot rod 72 inserts into corresponding recesses formed in arms 62R and 62L. Striker 86 and first magnet 78R are embedded in finger 66. First magnet 78L and threaded insert 76 are embedded into slider 68 to form an assembly. The assembly is inserted into slot 64 in arm 62L and secured from the other side by thumb screw 70.

With reference to FIGS. 8-9B, slider 68 and thumb screw 70 cooperate to selectively adjust the timer duration of timer 90. Finger 66 is suspended on pivot rod 72 such that first magnet 78R and second magnet 78L travel in the same arc. First magnet 78R and second magnet 78L cooperate to hold finger 66 in a cocked position when the magnets line up and magnetically couple.

The timer duration of timer 90 is controlled by positioning slider 68, which contains second magnet 78L, higher or lower in curved slot 64. Slider 68 is held in place at a desired position within curved slot 64 corresponding to a desired timer duration with thumb screw 70. FIGS. 11A-11C depict slider 68 secured at a lower position in curved slot 64 with thumb screw 70 to establish a relatively long timer duration. In contrast, FIG. 12 depicts slider 68 secured at a higher position in curved slot 64 with thumb screw 70 to establish a relatively short timer duration.

To start timer 90, one suspends hourglass 80 between the upper part of the arms 62L and 62R so that upper globe 84 containing sand 82 is on top. For a longer timer duration, one loosens thumb screw 70 and slides it lower in slot 64 before retightening it. For a shorter timer duration, one slides thumb screw 70 higher in slot 64. Adjusting the position of thumb screw 70 within slot 64 repositions slider 68 and second magnet 78L accordingly.

Once thumb screw 70 is retightened, one rotates finger 66 until first magnet 78R and second magnet 78L magnetically couple with each other. The magnetic coupling of first magnet 78R and second magnet 78L hold finger 66 in place until the weight of hourglass 80 pressing against finger 66 as hourglass 80 rotates breaks the magnetic coupling between first magnet 78R and second magnet 78L. When the magnetic coupling is broken, finger 66 swings forward and striker 86 strikes cymbal 84 to sound an alarm.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention of a different invention and whether they are different, broader, narrower or equal to scope to the original claims, are to be considered within the subject matter of the inventions described herein.

1. A timer, comprising:
an hourglass including:
a top globe;
a bottom globe; and
a neck connecting the top globe and the bottom globe and defining a sand passageway between the top globe and the bottom globe;
a frame pivotally supporting the hourglass at the neck with the bottom globe disposed below the top globe; and
a trigger pivotally coupled to the frame in a position to be engaged by the bottom globe when the hourglass pivots on the frame to a selected extent;
wherein:
the hourglass is configured to contain sand disposed inside one or more of the top globe, the bottom globe, and the neck;
the hourglass is configured to allow the sand to flow from the top globe to the bottom globe through the neck under the influence of gravity;
the hourglass pivots on the frame in response to sand flowing from the top globe to the bottom globe; and
the selected extent the hourglass must pivot for the bottom globe to engage the trigger corresponds to a selected amount of time.

2. The timer of claim 1, further comprising a sonic device configured to produce sound when engaged by the trigger in response to the trigger being engaged by the bottom globe.

3. The timer of claim 2, wherein the sonic device includes an acoustic bowl.

4. The timer of claim 3, wherein:
the sonic device further includes a sphere configured to engage the acoustic bowl after being engaged by the trigger; and
the acoustic bowl produces a sound when engaged by the sphere.

5. The timer of claim 4, wherein:
the frame defines a track including a lower end and an upper end;
the sphere is supported on the upper end of the track;
the acoustic bowl is disposed adjacent to the lower end of the track; and
the sphere rolls down the track from the upper end to the lower end and engages the acoustic bowl when the trigger engages the sphere.

6. The timer of claim 5, wherein the frame defines a seat at the upper end of the track to receive and support the sphere until the trigger engages the sphere and causes it to roll down the track.

7. The timer of claim 1, wherein:
the trigger includes a fixed finger; and
the timer further comprises a trigger adjustment mechanism pivotally coupled to the fixed finger, and
the trigger adjustment mechanism includes:
a variable finger pivotally connected to the fixed finger; and
a fastener configured to selectively secure the variable finger in a desired pivot position relative to the fixed finger.

8. The timer of claim 7, wherein selectively pivoting and fixing the variable finger towards the bottom globe adjusts the selected extent the hourglass must pivot for the bottom globe to engage the trigger.

9. The timer of claim 8, wherein selectively pivoting and fixing the variable finger towards the bottom globe reduces the selected extent the hourglass must pivot for the bottom globe to engage the trigger.

10. The timer of claim 7, wherein the variable finger drives the fixed finger to pivot relative to the frame when the variable finger is engaged by the bottom globe.

11. The timer of claim 2, wherein the sonic device includes a cymbal.

12. The timer of claim 11, wherein:
the cymbal is suspended from the frame in a path of the trigger when the trigger pivots relative to the frame; and
the cymbal creates a sound when contacted by the trigger.

13. The timer of claim 12, wherein:
the trigger is held in a cocked position spaced from the cymbal;
the trigger is pivoted out of the cocked position when the bottom globe engages the trigger,
the trigger pivots from the cocked position to a contact position under the force of gravity after being pivoted out of the cocked position; and
the trigger contacts the cymbal in the contact position.

14. The timer of claim 1, wherein:
the frame defines an elongate slot; and
the trigger is pivotally connected to the frame proximate the elongate slot.

15. The timer of claim 14, wherein:
the trigger includes a first magnetic member adjacent to the elongate slot;
the first magnetic member moves along the elongate slot when the trigger is pivoted relative to the frame; and
the timer further comprises a trigger adjustment mechanism disposed in the elongate slot and configured to adjust the extent to which the trigger is pivoted relative to the frame.

16. The timer of claim 15, wherein:
the trigger adjustment mechanism includes:
a slider member disposed in the elongate slot; and
a second magnetic member disposed on an end of the slider member proximate the trigger;
the trigger is fixed in a cocked position by magnetic attraction between the first magnetic member and the second magnetic member when the first magnetic member is aligned with the second magnetic member.

17. The timer of claim 16, wherein the trigger adjustment mechanism further includes a mechanical fastener to fix the slider member in a given position within the elongate slot.

18. The timer of claim 17, wherein selectively moving the slider member higher in the elongate slot sets the trigger closer to the bottom globe in the cocked position and adjusts the selected extent the hourglass must pivot for the bottom globe to engage the trigger.

19. The timer of claim 1, wherein the trigger includes a curved member and is pivotally connected to the frame at a medial position of the curved member.

20. The timer of claim 1, further comprising a base supporting the frame.
